(19) United States
(12) Patent Application Publication
(10) Pub. No.: US 2004/0168328 A1
(43) Pub. Date: Sep. 2, 2004

(54) Multiple orientation saw

(76) Inventors: Rickey J. Thomas, Manchester, MD (US); Robert Welsh, Hunt Valley, MD (US)

Correspondence Address: HARNESS, DICKEY & PIERCE, P.L.C., P.O. BOX 828, BLOOMFIELD HILLS, MI, 48303, US

(21) Appl. No.: 10/616,872

(22) Filed: Jul. 10, 2003

Related U.S. Application Data
(60) Provisional application No. 60/451,206, filed on Feb. 28, 2003.

(51) Int. Cl. B27B 21/00

(52) U.S. Cl. 30/517; 30/519

(57) ABSTRACT

A multiple orientation hand saw is provided including a plurality of blade mounting configurations including a first blade mounting section for supporting a blade in a vertical orientation on the handle and a second blade mounting section for supporting the blade in a cross-cutting orientation.

### CROSS-REFERENCE TO RELATED APPLICATIONS

This application claims the benefit of U.S. Provisional Application No. 60/451,206 filed on Feb. 28, 2003. The disclosure of the above application is incorporated herein by reference.

### FIELD OF THE INVENTION

The present invention relates to a hand saw, and more particularly to a hand saw capable of being converted from a regular vertical cut hand saw to a 90 degree flush cut orientation.

### BACKGROUND AND SUMMARY OF THE INVENTION

On a job site, it is often necessary for workers to utilize several different types of saws for different types of cutting operations. Plumbers typically utilize special saws for cutting PVC pipe. The types of cuts that are required for cutting PVC pipe sometimes require a blade that is vertical to the handle, while other times a 90 degree (flush cut) blade orientation is required for cutting pipes and other members flush to a surface such as for cutting drain pipe extending from a floor. Existing product designs, such as disclosed in U.S. Pat. No. 4,630,368, require the use of an additional component that is purchased separately and is easily lost or misplaced. Other configurations, such as that disclosed in U.S. Pat. No. 2,282,902, allow a blade to be mounted in multiple configurations, however, the 90 degree cross-cut orientation position of the blade is on the top of the handle which makes for awkward use by the user when trying to cut an object flush along a surface such as the floor.

Accordingly, the design of the present invention includes a plurality of mounting positions and mechanisms to facilitate mounting the blade in a 90 degree orientation on the bottom surface of the handle for use in tight spaces or flush cutting applications in either a right hand or a left hand direction.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the multiple orientation saw according to the principles of the present invention;

FIG. 2 is a side perspective view of the multiple orientation saw according to the principles of the present invention;

FIG. 3 is a bottom plan view of the hand saw according to the principles of the present invention;

FIG. 4 is a side view of a second embodiment of the multiple orientation saw according to the principles of the present invention;

FIG. 4A is a side view of a clamp plate for the multiple orientation saw of FIG. 4;

FIG. 5 is a side view of a third embodiment of the multiple orientation saw according to the principles of the present invention;

FIG. 5A is a partial cross-sectional view of the multiple orientation saw of FIG. 5 illustrating the insertion of a blade therein;

FIG. 5B is a partial cross-sectional view of the multiple orientation saw of FIG. 5 illustrating the engagement of the blade;

FIG. 6 is a side view of a fourth embodiment of the multiple orientation saw according to the principles of the present invention;

FIG. 7 is a side view of a fifth embodiment of the multiple orientation saw according to the principles of the present invention;

FIG. 7A is a side view of a clip for the multiple orientation saw of FIG. 7;

FIG. 8 is a side view of a sixth embodiment of the multiple orientation saw according to the principles of the present invention;

FIG. 9 is a side view of a seventh embodiment of the multiple orientation saw according to the principles of the present invention; and

FIG. 10 is a side view of an eighth embodiment of the multiple orientation saw according to the principles of the present invention.

FIG. 10A is a top view of the multiple orientation saw of FIG. 10.

### DETAILED DESCRIPTION OF THE PREFERRED EMBODIMENTS

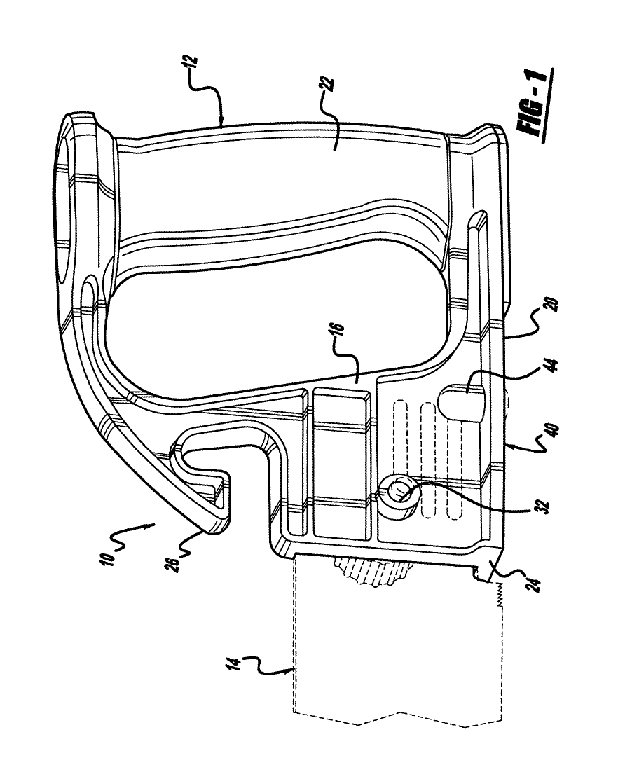

The following description of the preferred embodiments is merely exemplary in nature and is in no way intended to limit the invention, its application, or uses. FIGS. 1-10A disclose several alternative embodiments of the present invention in which like reference numerals are used to illustrate the same or similar elements.

FIGS. 1-3 disclose a multiple orientation saw having a plurality of blade mounting configurations according to the principles of the present invention. Saw 10 generally includes a handle portion 12 and a blade portion 14, which is adapted to be removably mounted to the handle 12. The handle 12 generally includes a left side face 16, a right side face 18 and a bottom face 20, which define a hand grip portion 22 and a blade mounting portion 24.

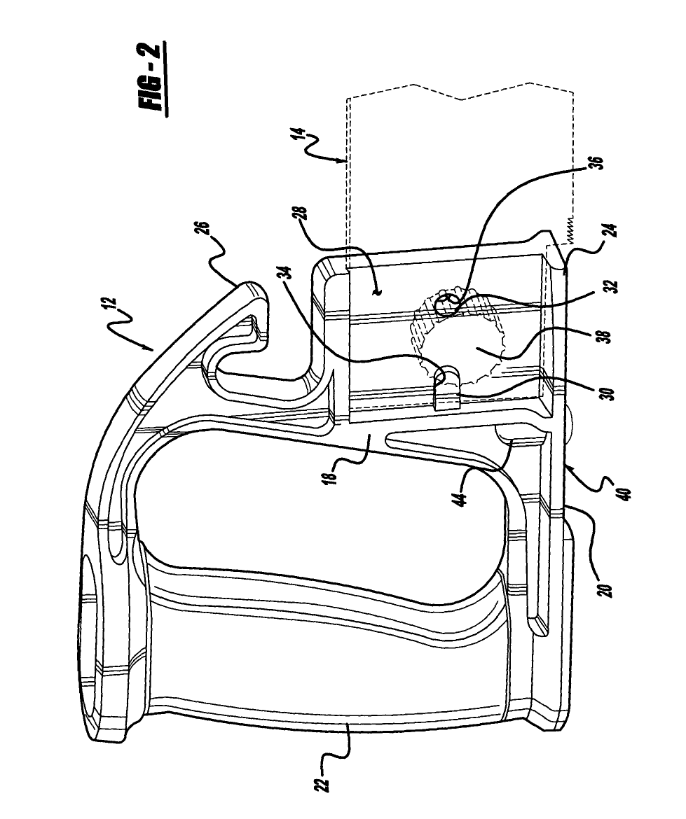

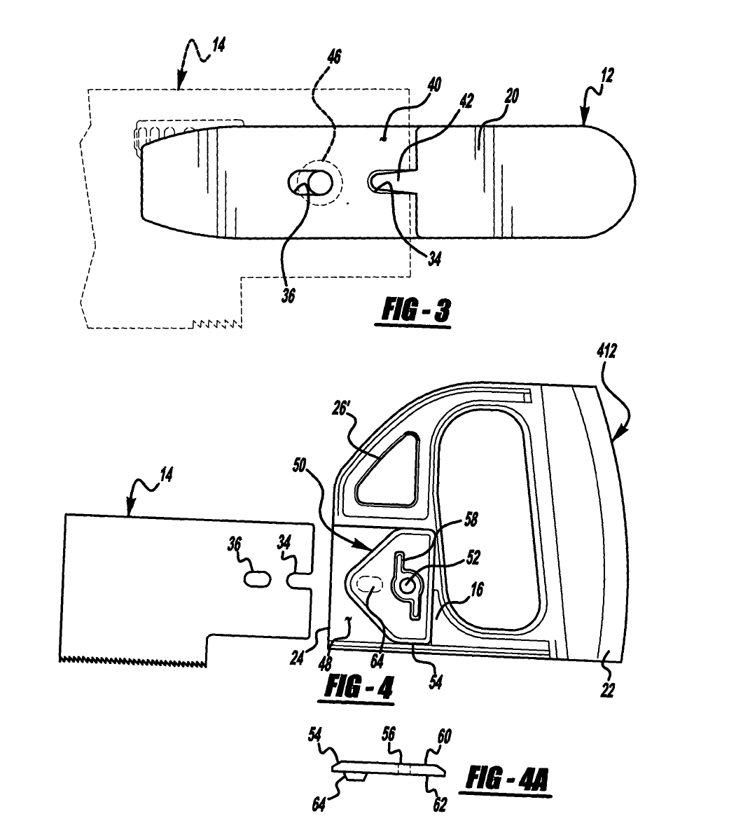

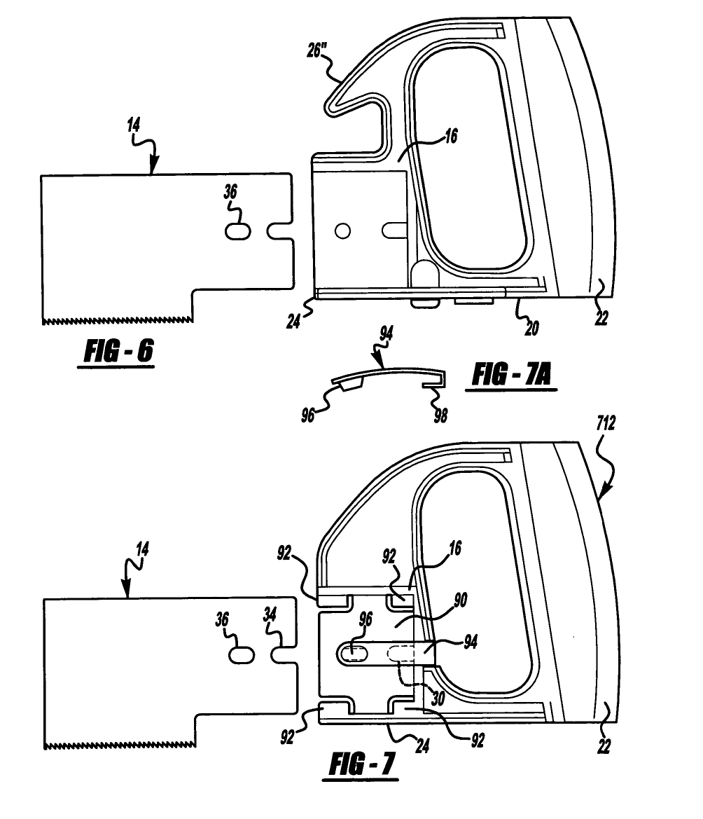

Additional features of the multiple orientation saw of the present invention include a hook member 26, for hanging and storing the saw 10 and a belt clip 27 (FIGS. 10, 10A), for securing the saw 10 to a belt strap. Disposed adjacent to the hand grip portion 22 and the blade mounting portion 24, between the left and right side faces 16, 18, is the hook member 26 having an open configuration as shown in FIGS. 1 and 2. The hook member 26 is generally molded as part of the handle 12. Alternatively, the hook member 26′ can have a closed configuration as illustrated in FIG. 4, or can have alternative shapes as shown by the hook member 26″ in FIG. 6. Similarly situated between the left and right side faces 16, 18 is the belt clip 27, as shown in FIGS. 10 and 10A. The in-line belt clip 27 hooks to a belt strap, tool pouch or the like, providing hands free transportation of the saw 10. Alternatively, the projection of the belt clip 27′ can be offset from either the left or the right side face 16, 18, as shown in FIG. 10A. The offset configuration allows the saw 10 to be hung from a parallel adjacent surface.

Referring to FIGS. 1 and 2, the blade mounting portion 24 includes a first blade mounting section 28, best illustrated in FIG. 2, disposed on the right side face 18 of the handle 12. The first blade mounting section 28 includes a key 30 and a screw boss 32. As best shown in FIG. 2, the blade 14 includes a recessed end slot 34 in an end of the blade 14 which receives the key 30 therein. The blade 14 also includes an aperture 36 for receiving a threaded screw 38 which is threaded into the screw boss 32 for securing the blade 14 to the handle 12 in a vertical cut orientation.

The blade mounting portion 24 of the handle 12 also includes a second blade mounting section 40 provided on the bottom face 20 of the handle 12, as best shown in FIG. 3. The second blade mounting section 40 includes a key 42 adapted to be received by the recessed end slot 34 of the blade 14. A screw boss 44 on the bottom face 20 receives a threaded fastener 46 therein which extends through the aperture 36 in the blade 14 for securely mounting the blade 14 to the handle 12 in the horizontal or cross cut orientation.

With reference to FIG. 3, an assembled view of the bottom face 20 of the handle 12 is shown with the blade 14 having the recessed end slot 34 for receiving the key 42 and the threaded fastener 46 received by the screw boss 44 for securing the blade 14 to the handle 12 in the cross cut orientation. It should be noted that the handle 12 and blade 14 are so configured that the blade 14 can be mounted in either a left or right hand flush cutting orientation.

FIG. 4 shows an alternative embodiment of a handle 412 wherein the blade mounting portion 24 includes a mounting surface 48, disposed on the left side face 16 of the handle 412, and a clamp assembly 50 for securing the blade 14 into position on the handle 412. The mounting surface 48 includes a threaded shaft 52 adapted to receive the recessed end slot 34 of blade 14. Clamp assembly 50 includes a clamp plate 54 including a hole 56 and a wing nut 58. As best shown in FIG. 4A, the clamp plate 54 has a top and a bottom side 60, 62, respectively, which includes a pin 64 disposed on the bottom side 62 which is adapted to be received by the aperture 36 in blade 14. Once received between the mounting surface 48 and the clamp plate 54, the blade 14 is secured into position by tightening the wing nut 58 onto the threaded shaft 52. The clamp assembly 50 may be removably attached to the mounting surface 48 by loosening and removing the wing nut 58 from the threaded shaft 52 or, in the alternative, the threaded shaft 52 may include a capped or otherwise blocked end preventing complete removal of the wing nut 58. The saw 10, as shown in FIG. 4, also includes a hook member 26′ in a closed configuration molded into the handle 12.

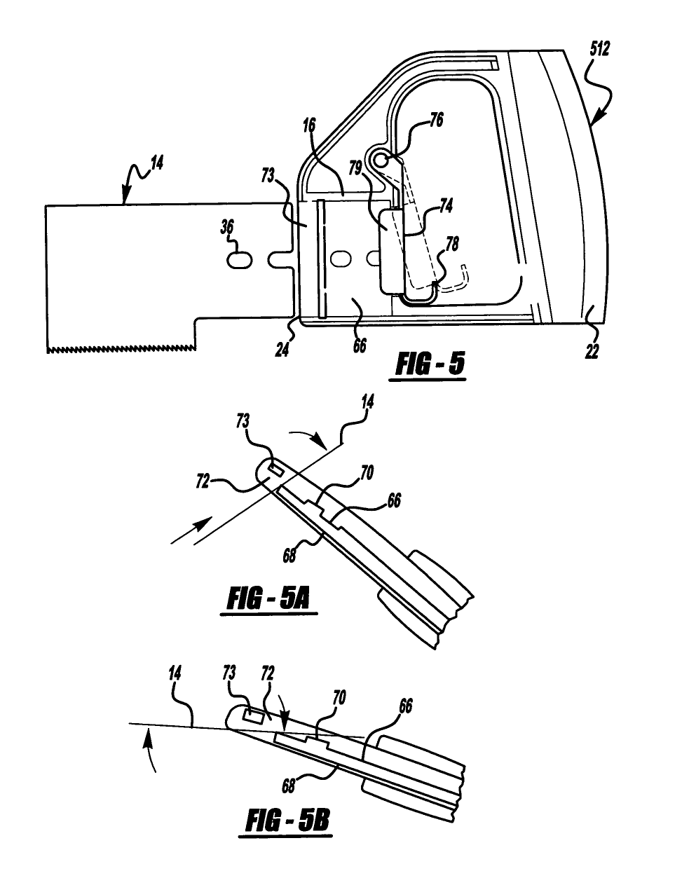

FIGS. 5, 5A and 5B show an alternative embodiment of a handle 512 wherein the blade mounting portion 24 includes front and back mounting surfaces 66, 68, respectively, for securing the blade 14 onto the handle 12. The front surface 66 includes a pin 70, adapted to receive aperture 36 of blade 14, and an insertion slot 72, extending the width of the blade 14 between the front mounting surface 66 and a front support bar portion 73 offset laterally from the front mounting surface 66 as best illustrated in FIGS. 5A and 5B. The blade 14 mounts to the front surface 66 by positioning the blade 14 perpendicular to the back mounting surface 68, as best shown in FIG. 5A, and inserting the blade 14 upward through the insertion slot 72. The inserted portion of the blade 14, as best shown in FIG. 5B, tilts downward onto the front mounting surface 66, engaging the aperture 36 of the blade 14 onto the pin 70 preventing the blade 14 from slipping back through the insertion slot 72. The front support bar portion 73 provides lateral support to the blade 14.

Further securing the blade 14 to the front mounting surface 66 is a clip 74, shown in FIG. 5, having a pivot pin 76 at one end and a finger tab 78 at the other end. The clip 74 attaches to the handle 512 via the pivot 76, which is constructed either as an integrated part of the handle 512 or as a removably attached pivot pin 76. The clip 74 rotates about the pivot 76 using the finger tab 78 as leverage. The clip 74 holds the blade 14 in place using a pair of clamp plates 79 that clamp the blade 14 and the mounting surface 66 when engaged.

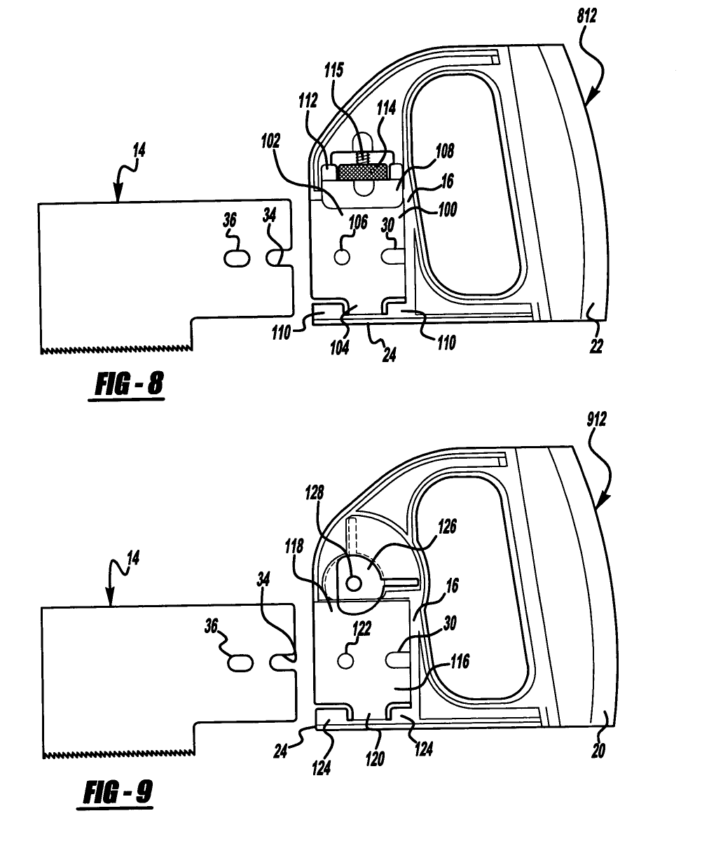

FIG. 7 illustrates an alternative embodiment of a handle 712 wherein the blade mounting portion 24 includes a side mounting surface 90 with raised tabs 92 at each corner. The tabs 92 guide the blade 14 into position onto the mounting surface 90 and prevent side to side slipping. The blade 14 is secured to the mounting surface 90 by a flexible clip 94, as best shown in FIG. 7A, which includes a pin 96 at one end, adapted to be received by aperture 36 in blade 14, and a hook-like member 98 at the opposite end that attaches to the mounting surface 90 securing the clip 94 to the handle 712. As the blade 14 is slid onto the mounting surface 90, the pin 96 slides through the recessed end slot 34 eventually hitting the closed edge of the end slot 34 causing the clip 94 to rise onto the blade 14. The blade 14 is completely in position on the mounting surface 90 when the pin 96, now gliding on top of the blade 14, drops into the aperture 36 of the blade 14 and the key 30 is received in the recessed end slot 34 in the blade 14. The clip 94 is made from a spring like material providing enough rigidity to secure the blade into position, yet enough flexibility to allow the blade 14 to slide underneath the pin 96.

Similar to the mounting configuration in FIG. 7, the handle 812 in FIG. 8 includes a side mounting surface 100 having a top and a bottom end 102, 104, respectively. In addition, the side mounting surface 100 includes a pin 106 adapted to receive the aperture 36 of the blade 14 and key 30 which is received in the recessed end slot 34 in the blade 14. The blade 14 is guided into position by a clamp plate 108, located at the top end 102 of the side mounting surface 100, and by raised tabs 110, located at the bottom end 104 of the side mounting surface 100. The clamp plate 108, the tabs 110, the pin 106 and the key 30 retain the blade 14 in position preventing side to side movement. The top end 102 of the side mounting surface 100 includes a clamp assembly 112 that captures and secures the blade 14 onto the mounting surface 100. The clamp assembly 112 includes a threaded nut 114 threadedly engaging threaded shaft 115. Actuation of the threaded nut 114 compresses the clamp plate 108 onto the blade 14.

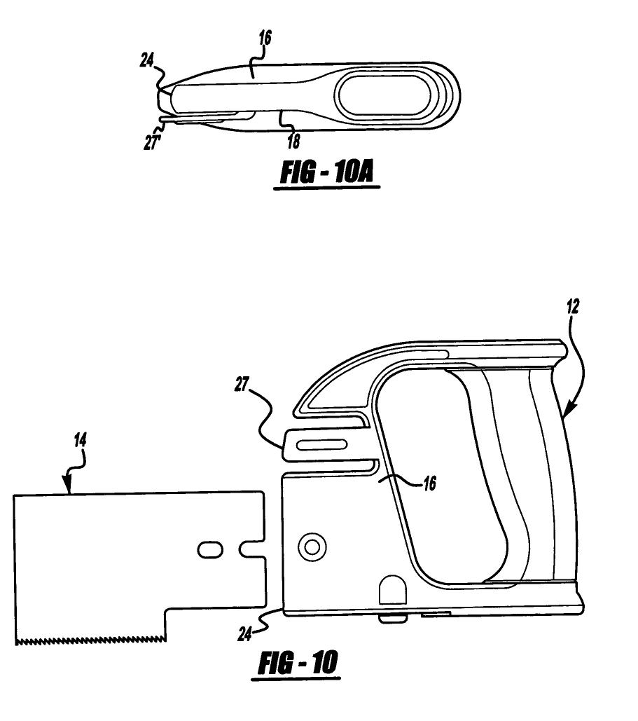

FIG. 9 illustrates an alternative embodiment of the handle 912 wherein the blade mounting portion 24 includes a side mounting surface 116 including a top and a bottom end 118, 120, respectively, and a pin 122 adapted to receive the aperture 36 of the blade 14 and a key 30 adapted to be received in the recessed end slot 34. The bottom end 120 includes a pair of raised tabs 124 used to guide the blade 14 into position and prevent side to side slippage. A cam lever 126 is attached to the handle 912 via a pivot 128. The cam lever 126 rotates about the pivot 128 capturing the top of the blade 14 securing it to the mounting surface 116.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A hand saw, comprising;
a handle including a hand grip portion and first and second blade mounting portions, said first blade mounting portion being disposed on a side surface of said handle and said second blade mounting portion being disposed on a bottom surface of said handle; and
a blade adapted to be removably mounted to either of said first and second blade mounting portions.

2. The hand saw according to claim 1, wherein said first and second blade mounting portions each include a screw boss for receiving a blade mounting screw therein.

3. The hand saw according to claim 2, wherein said first and second blade mounting portions each include a key adapted to be received in an end slot in said blade.

4. The hand saw according to claim 1, wherein said first and second blade mounting portions each include a key adapted to be received in an end slot in said blade.

5. The hand saw according to claim 1, wherein said handle includes a hook member for hanging said hand saw.

6. The hand saw according to claim 3, wherein said handle includes a hook member for hanging said hand saw.

7. The hand saw according to claim 1, wherein said first and second blade mounting portions each include a clamp assembly having a pin adapted to be received in an aperture in said blade.

8. The hand saw according to claim 7, wherein said clamp assembly includes a wing nut for securing said clamp assembly to said blade.

9. The hand saw according to claim 7, wherein said clamp assembly includes a clamp plate.

10. The hand saw according to claim 1, wherein said first blade mounting portion includes a threaded hole for receiving a fastener therein.

11. The hand saw according to claim 10, wherein said second blade mounting portion includes a threaded hole for receiving a mounting screw therein.

12. The hand saw according to claim 11, wherein said handle includes a hook member.

13. A hand saw comprising:
a handle including a grip portion and a body portion, said body portion having a blade mounting surface disposed on a side surface of said handle;
a blade adapted to be removably mounted to said blade mounting surface; and
a clip disposed on said body portion mounting surface adapted to secure said blade to said blade mounting surface, said clip includes a first and second end, said first end attached to said body portion by a pivot, said second end movable about said pivot having a tab for securing said blade to said blade mounting surface.

14. The hand saw according to claim 13, wherein said blade mounting surface includes an insertion slot adapted to receive said blade.

15. The hand saw according to claim 14, wherein said blade mounting surface includes a pin adapted to be received by an aperture in said blade.

16. A hand saw comprising;
a handle including a grip portion and a body portion, said body portion including a blade mounting surface disposed on a side surface of said handle;
a blade adapted to be removably mounted to said blade mounting surface; and
a raised tab disposed on said blade mounting surface for slidably receiving and securing said blade.

17. The hand saw according to claim 16 wherein said body portion includes a retaining clip having a first and second end, said first end removably attached to said body portion, said second end having a pin adapted to be received by a blade aperture securing the blade therein.

18. The hand saw according to claim 17, wherein said handle includes a hook member for hanging said hand saw.

19. A hand saw comprising:
a handle including a grip portion and a body portion, said body portion including a blade mounting surface disposed on a side surface of said handle;
a blade adapted to be removably mounted to said blade mounting surface; and
a clamp assembly disposed on said body portion including a threaded nut and a raised tab to secure placement of said blade therein.

20. The hand saw according to claim 19, wherein said blade mounting surface includes a pin adapted to be received by an aperture in said blade.

21. A hand saw comprising:
a handle including a grip portion and a body portion, said body portion including a blade mounting surface disposed on a side surface of said handle;
a blade adapted to be removably mounted to said blade mounting surface; and
a cam lever disposed on said body portion rotatable about a pivot and adapted to secure said blade therein.

22. A hand saw comprising:
a handle including a grip portion and a body portion, said body portion including a blade mounting surface disposed on a side surface of said handle;
a blade adapted to be removably mounted to said blade mounting surface; and
a belt clip disposed on said handle for hanging said hand saw.
